(19) United States
(12) Patent Application Publication
(10) Pub. No.: US 2007/0018611 A1
(43) Pub. Date: Jan. 25, 2007

(54) Battery detection interface

(75) Inventors: Jere Anttila, Turku (FI); Markus Aaltonen, Piikkio (FI); Mika Hurula, Halikko (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/179,785

(22) Filed: Jul. 11, 2005

(51) Int. Cl. H02J 7/00

(52) U.S. Cl. 320/114

(57) ABSTRACT

It is an objective of the present invention to provide an interface arrangement between a battery element (302) and an electronic device (301), e.g. a mobile phone, for reliable battery identification and for removal detection. The objectives of the invention are achieved with a combined analogue and digital interface between a battery element (302) and an electronic device (301) so that both analogue and digital data can be transferred from a battery element to an electrical device. Reliable digital authentication is used for determining if a battery element connected to an electronic device represents new battery technology. An analogue signalling scheme is used for identifying different battery elements representing older-generation battery technologies and for detecting battery removals. Digital data read from the battery element (302) may contain, for example, information for charging control, a discharge curve, and a serial number of the battery element.

### FIELD OF THE INVENTION

The invention relates to a method and arrangement for changing information between a battery element and a battery-powered electronic device. Especially the invention concerns an electrical interface between a battery element and an electronic device such that information related to a battery element can be transferred to an electronic device.

### BACKGROUND OF THE INVENTION

The widespread use of battery-powered electronic devices (e.g. cellular mobile phones, laptops, palmtops) with high performance relies on efficient battery utilization. These kinds of devices typically use re-chargeable batteries like lithium-ion, nickel-cadmium or nickel metal hydride batteries. New battery technology gives longer working time to battery-powered devices through providing a wider voltage range. A new-technology battery can be charged up to a higher voltage and/or it can be discharged down to a lower voltage than a corresponding older generation battery. Many times the users of battery-powered devices are willing to use not only batteries made by the vendor of a device but also batteries made by third parties. For example, a user may want to have an additional backup battery for his battery-powered device. A spare part battery manufactured by a third party and representing older-generation battery technology may be considerably cheaper than a new-technology battery manufactured by the vendor of the electronic device. Therefore, at certain times a new-technology battery is used with a battery-powered electronic device while at certain other times an older-generation battery is used with the same electronic device. A system for controlling charging of a battery or a part of the system is many times integrated into an electronic device, like in a case of e.g. a mobile phone. A system for charging control has to be able to identify new technology batteries from conventional technology batteries that have lower full charging voltage. If a battery realized with a conventional technology is charged using too high voltage it will be overcharged. An overcharged battery may cause a safety hazard and it may even explode.

### DESCRIPTION OF THE PRIOR ART

One traditional method is to design a mechanical coupling between a battery element and an electronic device in a way that only the battery elements made by the vendor of the device are able to fit with the device e.g. with a cellular mobile phone. The advantage reached by this method is, however, only temporary because a third party battery manufacturer may copy the mechanical shape of a battery element. If a third party battery maker does not copy the technology inside a battery element, a copied battery element causes a serious safety risk when used with the electronic device.

FIG. 1 presents a prior art solution for identifying a type of a battery element connected to an electronic device. This kind of arrangement is commonly used for example in mobile phones. A battery element 102 is connected to an electronic device 101 via galvanic contact elements 111, 112 and 113. The battery element 102 comprises a battery cell unit 125 and a battery size indication (BSI) resistor 124. The battery cell unit 125 comprises one or more battery cells that can be connected in many different ways, e.g. serial connected, parallel connected, or groups of serial connected cells can be parallel connected, etc. Block 103 in the electronic device 101 represents means for realizing such functions of the device 101 that have no role in the viewpoint of the present invention, e.g. in a case of a mobile phone, block 103 comprises, among others, means for wireless telecommunication. The electronic device 101 comprises a pull-up resistor 123 that together with the BSI resistor 124 performs voltage slicing so that the voltage Um resulting from the voltage slicing is

$$Um = \frac{R\_BSI}{R\_BSI + R\_up} \times Ub , \qquad ( 1 )$$

where Ub is the battery voltage produced by the battery cell unit 125, R_BSI is the resistance [Ω] of the BSI resistor 124 and R_up is the resistance [Ω] of the pull-up resistor 123. Voltage Um is measured by a control element 104.

The type of the battery element 102 is identified by the control element 104 based on the value of the measured voltage Um.

The battery cell unit 125 is charged by an external source of electrical energy 128 that is connected to the device 101 via galvanic contact elements 114 and 115. Charging current and/or voltage applied to the battery cell unit 125 are/is controlled by a switch 129 and a regulator element 126 that are controlled by the control element 104. The control element selects a suitable charging algorithm according to the identified type of the battery element 102. The selected charging algorithm determines, among others, the maximum allowable values of charging current and charging voltage. The maximum allowable values may be functions of e.g. a charging state of the battery cell unit 125. The charging state can be measured for example by opening the switch 129 at certain time intervals and by measuring the voltage produced by the battery cell unit 125. The charging algorithm may also determine what kind of phenomenon is used for indicating a full charge state. A usable indicator for a full charge state depends on the chemistry of a battery cell. For example, with certain battery types a level of voltage produced by the battery cell unit can be used as an indicator for a full charge state.

When the battery element 102 is removed the BSI resistor 124 is disconnected and the pull-up resistor 123 pulls the measured voltage Um up to voltage of a positive rail 121. The detection of the removal of the battery element 102 is based on the resulting step-wise increase on the measured voltage Um. In order to detect the removal of the battery element 102 correctly, the voltage of the positive rail 121 has to be maintained for a time period long enough after an electrical connection via the galvanic contact element 112 is broken. This can be accomplished by designing the galvanic contact elements 111, 112, and 113 in a way that when the battery element 102 is removed the electrical connection via the galvanic contact element 112 is broken earlier than electrical connections via the galvanic contact elements 111 and 113, e.g. by using a shorter pin in the galvanic contact element 112 than in the galvanic contact elements 111 and 113. Another alternative is to use a capacitive energy storage 127 that maintains the voltage of the positive rail 121 after the removal of the battery element 102 for so long a time period that the removal of the battery element 102 can be correctly detected.

A drawback of distinguishing new-technology battery elements from older-generation battery elements based on the measured voltage Um is the fact that for third parties it is very straightforward to produce battery elements whose BSI resistors are similar to those of new-technology battery elements but a battery cell unit represent older-generation technology. In other words, there is a significant risk that on the market there will be such counterfeit battery elements that from the viewpoint of the distinguishing method resemble new-technology battery elements but that actually are older-generation battery elements. This kind of counterfeit battery element causes a serious safety risk when used with an electronic device.

It would be technically possible to block out all except those battery elements that are made by the vendor of an electronic device. This kind of arrangement is shown in FIG. 2. A battery element 202 comprises an identification circuit 203 (ID-IC). The electronic device 201 comprises means 204 for communicating with the identification circuit via a communication bus 205 that can be a single or a multi wire bus. A control element 206 uses a heavily encrypted authentication algorithm for checking if the device vendor is the manufacturer of the battery element 202. If the result of the checking is negative the control element 206 does not allow charging of a battery. In addition to this, operation of the elements 207 that perform the main functions, e.g. for telecommunication, of an electronic device 201 can be denied. This approach has two negative consequences. Firstly, when third party battery makers notice their business is going to end, they are focusing to break the encrypting of the authentication algorithm. Secondly, allowing only battery elements manufactured by a device vendor may be even commercially unattractive.

Publication U.S. Pat. No. 6,018,228 presents a method and arrangement for battery identification and for obtaining charging parameters. Also in this method a battery element comprises a module that contains digital identification data plus charging parameter values, such as maximum allowable voltage and maximum allowable current. A controller element within an electronic device reads the identification data and the charging parameters. Blocking out battery elements made by third parties can be avoided by defining a default charging program that is used if the communication between the battery element and the electronic device fails. A feature of this method is the fact that the default-charging program has to be so light-handed that a battery element based on any technology does not cause a safety risk. Another feature is the fact that the widespread battery removal detection method described above is not supported.

In the view of various limitations of battery identification according to prior art, it would be desirable to avoid or mitigate these and other drawbacks and limitations associated with the prior art.

### BRIEF DESCRIPTION OF THE INVENTION

It is an objective of the present invention to provide an interface arrangement and a method for reliable battery identification and for removal detection, the invention allowing the drawbacks associated with the prior art to be eliminated or reduced.

The objectives of the invention are achieved with a combined analogue and digital interface between a battery element and an electronic device so that both analogue and digital data can be transferred from a battery element to an electrical device. Reliable digital authentication is used for determining if a battery element connected to an electronic device represents new battery technology. An analogue signalling scheme is used for identifying different battery elements representing older-generation battery technologies and for detecting battery removals.

In this document a term ‘digital data’ means a piece of information that can represent only a finite number of different values. A term ‘analogue data’ means a piece of information that may represent infinite number of different values. For example, a value of voltage Um in FIG. 1 represents analogue data, because this data can represent infinite number of different voltage division ratios according to equation 1. An analogue data associated with a battery element is represented by one or more properties of one or more components comprised by the battery element. For example in FIG. 1, the resistance of the BSI-resistor represents analogue data associated with the battery element. Digital data associated with a battery element can be stored in a storage unit, e.g. a read only memory, that can be integrated into the battery element.

Signals carrying analogue data and signals carrying digital data are transferred via electrical coupling elements between a battery element and an electronic device in a way that there is no need for any additional electrical coupling element compared to a case in which only analogue data is transferred. Various signals carried by a common propagation path may be separated from each other in many known ways. For example, separation can be based on frequency division when different signals occupy different bands in the frequency domain, separation can be based on time division when different signals are transferred during different non-overlapping time intervals, or separation can be based on a combination of these two methods.

The invention yields appreciable benefits compared to prior art solutions:
new-technology battery elements are separated in a reliable way from old or conventional battery elements that have lower full charging voltage,
battery elements manufactured by a third party are not blocked out but they are handled in a safe way,
a battery element removal detection works for a wide variety of different battery element types in which a widely used analogue signalling scheme is used,
counterfeit battery elements that resemble new-technology batteries from the viewpoint of analogue identification are separated in a reliable way from new-technology battery elements with the aid of digital identification,
transfer of both analogue data and digital data does not increase the number of electrical coupling elements between a battery element and an electronic device.

An interface arrangement according to the invention between a battery element and an electronic device comprises at least two electrical coupling elements between the battery element and the electronic device, and the combined analogue and digital interface is characterized in that it comprises:
a storage unit for digital data associated with the battery element, the storage unit being a part of the battery element,
a component disposed to represent analogue data associated with the battery element, the component being a part of the battery element,
communication means for transferring said analogue data from the battery element to the electronic device via at least one of the electrical coupling elements,
communication means for transferring said digital data from the battery element to the electronic device via at least one of the electrical coupling elements, and

The above-mentioned electronic device can be, for example, a mobile phone.

In this document those parts of communication means for transferring analogue/digital data that are located in a battery element are called communication means for making analogue/digital data accessible to an electronic device. Correspondingly, those parts of communication means for transferring analogue/digital data that are located in the electronic device are called communication means for reading analogue/digital data from the battery element to the electrical device.

A battery element according to the invention comprises at least one rechargeable battery cell and at least two electrical coupling elements for forming electrical connections to an electronic device, and the battery element is characterized in that it comprises:
a storage unit for digital data associated with the battery element,
a component disposed to represent analogue data associated with the battery element,
communication means for making said analogue data accessible to the electronic device via at least one of the electrical coupling elements, and
communication means for making said digital data accessible to the electronic device via at least one of the electrical coupling elements.

An electronic device according to the invention comprises at least two electrical coupling elements for forming electrical connections to a battery element, and the electronic device is characterized in that it comprises:
communication means for reading analogue data from the battery element via at least one of the electrical coupling elements, and
communication means for reading digital data from the battery element via at least one of the electrical coupling elements.

A method according to the invention for identification a battery element electrically connected to an electronic device via at least two electrical coupling elements is characterized in that the method comprises:
reading analogue data from the battery element to the electrical device via at least one of the electrical coupling elements, and
reading digital data from the battery element to the electrical device via at least one of the electrical coupling elements.

A software product according to the invention for identification a battery element electrically connected to an electronic device via at least two electrical coupling elements is characterized in that the software product comprises:
software means stored on a readable medium for execution by a processor, the software means
for reading analogue data from the battery element to the electrical device via at least one of the electrical coupling elements, and
for reading digital data from the battery element to the electrical device via at least one of the electrical coupling elements.

Features of various advantageous embodiments of the invention are listed in the appended depending claims.

The exemplary embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The invention and its other advantages are explained in greater detail below with reference to the preferred embodiments presented in a sense of examples and with reference to the accompanying drawings, in which

FIG. 1 shows an interface arrangement based an analogue signalling between a battery element and an electronic device according to prior art,

FIG. 2 shows an interface arrangement based on transfer of digital signals between a battery element and an electronic device according to prior art,

FIG. 3 shows a combined analogue and digital interface between a battery element and an electronic device according to an embodiment of the invention,

FIGS. 4a-4c show timing diagrams of an exemplary line code for transferring digital data from a battery element to an electronic device,

FIG. 5 shows a combined analogue and digital interface between a battery element and an electronic device according to an embodiment of the invention,

FIG. 6 shows a flowchart for a battery identification method according to an embodiment of the invention,

FIG. 7 shows a flowchart for a battery identification method according to an embodiment of the invention,

FIG. 8 shows a combined analogue and digital interface between a battery element and an electronic device according to an embodiment of the invention,

FIG. 9 shows a combined analogue and digital interface between a battery element and an electronic device according to an embodiment of the invention.

### DETAILED DESCRIPTION OF THE PREFERRED EMBODIMENTS OF THE INVENTION

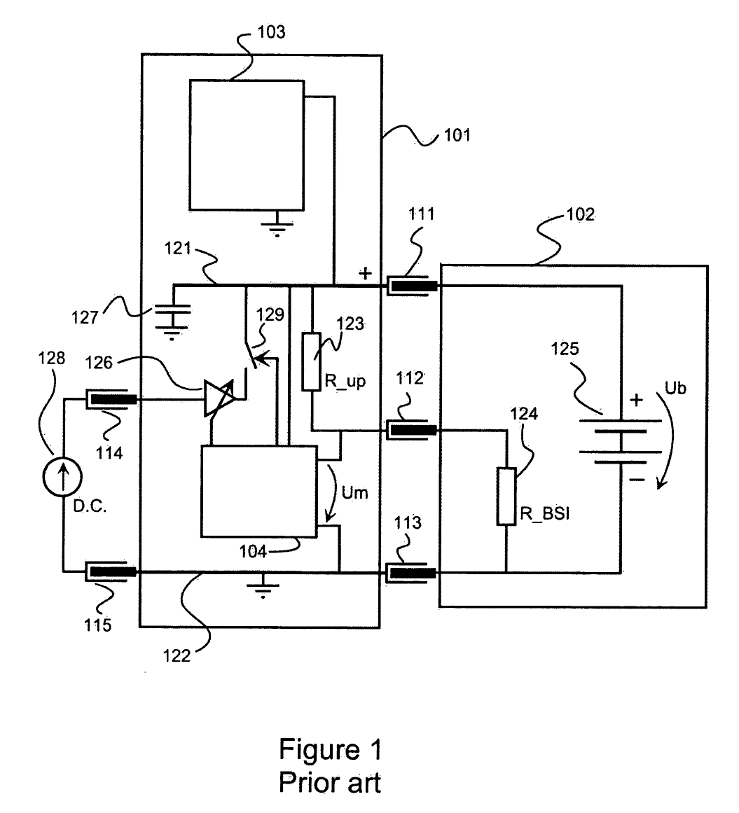

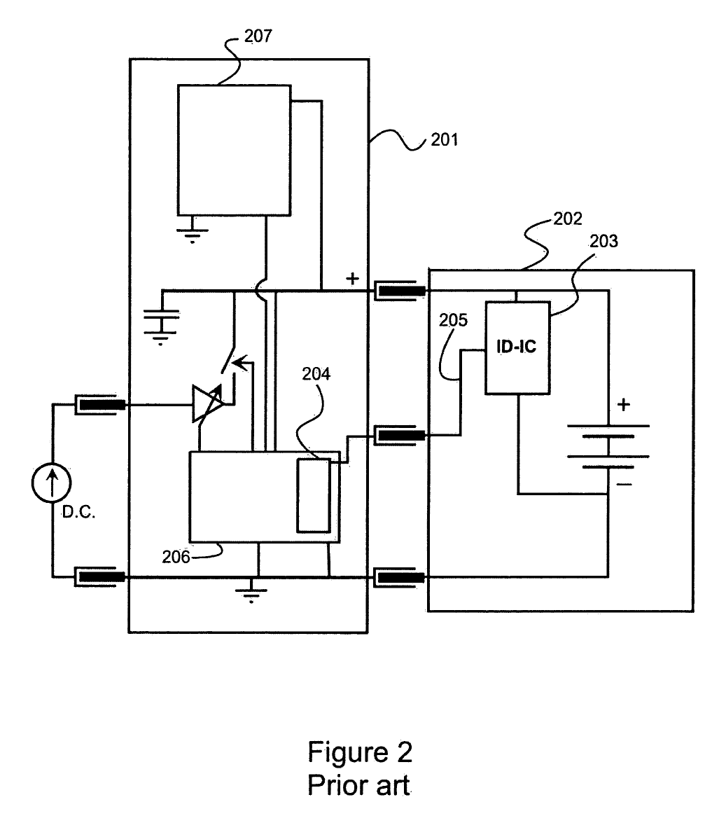

FIGS. 1-2 have been explained above in the description of the prior art.

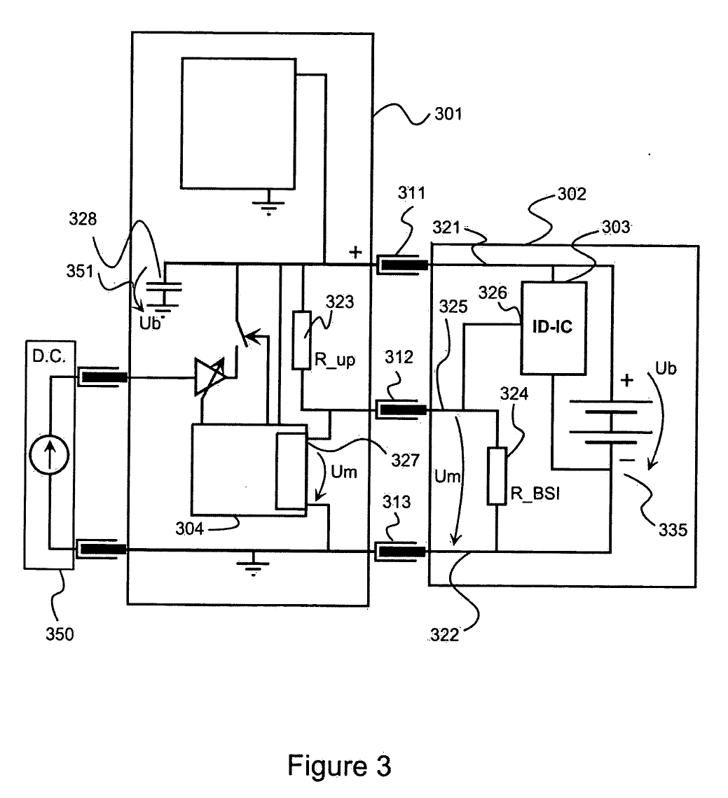

FIG. 3 shows a combined analogue and digital interface between a battery element and an electronic device according to a preferred embodiment of the invention. A battery element 302 comprises an identification circuit 303 (ID-IC) and a BSI-resistor 324. Resistance of a BSI-resistor represents analogue data associated with the battery element. The identification circuit 303 comprises a storage unit for digital data and a logic unit needed in transfer of the digital data to an electronic device 301. The electronic device comprises a control element 304 and a pull up resistor 323. The electrical device 301 and the battery element 302 are coupled with each other via electrical coupling elements 311, 312, and 313. The control element 304 comprises a measuring unit for measuring voltage Um over the BSI resistor 324 and a logic unit needed in transfer of digital data from the identification circuit 303. The pull up resistor 323, the electrical coupling elements 311, 312, and 313, and the measuring unit of the control element 304 are parts of communication means for transferring analogue data from the battery element 302 to the electronic device 301. Measuring the voltage over the BSI-resistor is a special case of supplying the BSI-resistor with electrical power and measuring an electrical quantity that depends at least partly on the resistance of the BSI-resistor. Also current through the BSI-resistor can be the electrical quantity that is measured.

In this embodiment of the invention, combining digital data transfer with the above-described analogue interface is accomplished in a cost effective way with using only a small amount of additional electrical components compared with a case shown in FIG. 1. Communication means for transferring digital data from the battery element 302 to the electronic device 301 are described below.

A transfer of digital data using only a small amount of additional electrical components is based on the fact that in addition to ‘plus’ and ‘minus’ electrical conductors 321 and 322 between the electronic device 301 and the battery element 302 there is a third electrical conductor 325 an impedance of which with respect to the ‘plus’ and ‘minus’ conductors 322 and 321 is so high that its voltage can be altered by the identification circuit 303 and by the control element 304. The impedance of conductor 325 with respect to the ‘plus’ and ‘minus’ conductors 321, 322 is substantially the resistance of a parallel connection of the BSI resistor 324 and the pull-up resistor 323. The resistance of a serial connection of the BSI resistor 324 and the pull-up resistor 323 has to be high, because otherwise a power loss in the serial connection of these two resistors would be too high for a battery-powered device. The resistance of the BSI resistor 324 has to be so high compared with the resistance of the pull-up resistor 323 that the voltage across the BSI-resistor 324 can be measured with a reasonable accuracy. It is assumed here that also the resistance of the pull-up resistor 323 is reasonably high. If this is not the case the situation can be treated by arranging a switching system that disconnects the pull-up resistor 323 while digital data is transferred (not shown in FIG. 3). Therefore, the impedance level of conductor 325 with respect to the ‘plus’ and ‘minus’ conductors 321, 322 is sufficiently high for transfer of digital data in a form of voltage message. The ‘plus’ and ‘minus’ conductors 321 and 322 and the third electrical conductor 325 are coupled to electronic device via the electrical coupling elements 311, 313 and 312, respectively. The electrical coupling elements 311, 312 and 313 are preferably galvanic contact elements. The principles associated with this embodiment are usable also if a +/−polarity of a battery cell unit 335 is interchanged.

In this document a conductor whose voltage with respect to ‘plus’ and ‘minus’ poles of a battery cell unit is varied for transferring digital data is said to be the conductor via which the digital data is transferred. For example, in the system shown in FIG. 3 the digital data is said to be transferred via conductor 325 in spite of the fact that transferring digital data needs also a path for return current; the path for return current is conductor 321 or 322 depending on a situation.

A one-wire data transfer arrangement is used for transferring digital data via conductor 325 from the identification circuit 303 to the control element 304. An example of a one-wire data transfer arrangement for transferring digital data via the conductor 325 is described below. Terminal 327 of the control element 304 is either in a low impedance state (Low-Z) or in a high impedance state (Hi-Z) with respect to the ‘minus’ conductor 322. Correspondingly, terminal 326 of the identification circuit 303 is either in a low impedance state or in a high impedance state. A Low-Z impedance of the terminal 327 is substantially bigger than that of the terminal 326. Both the Low-Z impedance of the terminal 327 and the Low-Z impedance of the terminal 326 are substantially smaller than the resistance of a parallel connection of the BSI resistor 324 and the pull-up resistor 323. Both a Hi-Z impedance of the terminal 327 and a Hi-Z impedance of the terminal 326 are substantially bigger than the resistance of a parallel connection of the BSI resistor 324 and the pull-up resistor 323. With this kind of impedance arrangement the control circuit 304 is able to give commands to the identification circuit 303 by forcing voltage Um up/down when the identification circuit is in the high impedance state. A possible down forcing of voltage Um accomplished by the control circuit 304 overpowers the pulling up by the pull-up resistor 323. The identification circuit 303 can respond by using its own means for changing the potential of conductor 325; a possible down forcing overpowers also the pulling up by the pull-up resistor 323.

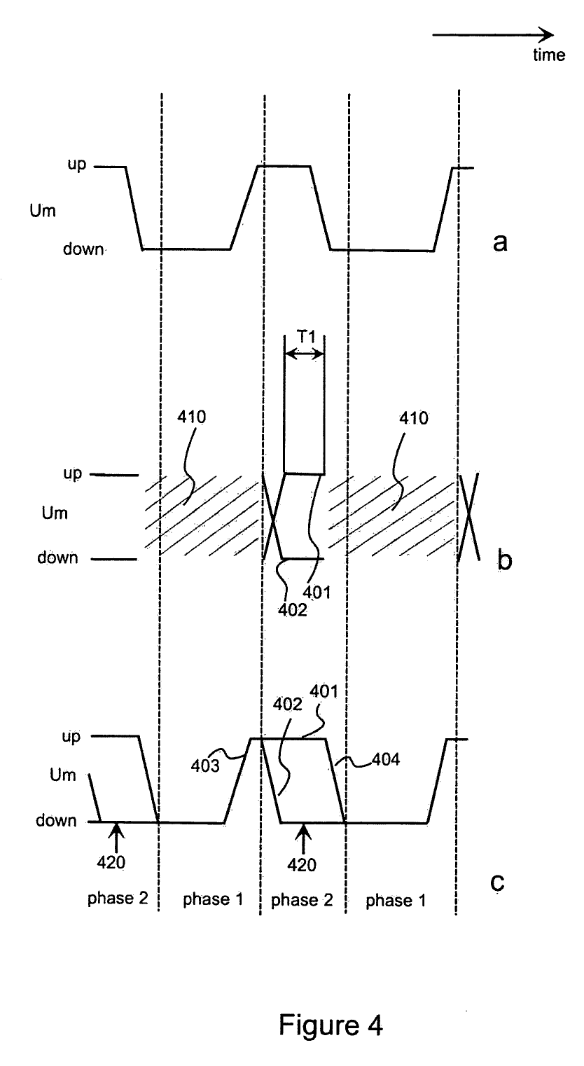

A timing diagram of an exemplary line code for transferring digital data from the identification circuit 303 to the control circuit 304 is shown in FIGS. 4a, 4b and 4c. FIG. 4a shows the waveform of Um if the input/output terminal 326 of the identification circuit 303 were all the time in the high impedance state. FIG. 4b shows the waveform of Um if the input/output terminal 327 of the control element 304 were all the time in a high impedance state. FIG. 4c shows the waveform of Um when the system is operating as described below. This exemplary line code works as follows:
At a beginning of phase 1 the input/output 326 of the identification circuit 303, hereinafter ID-IC, is in the high impedance state 410 and voltage Um is kept down (has been forced down) by the control element 304. A bit-pointer that is maintained by a logic unit of the ID-IC points at a certain bit of the digital data stored in a memory unit of the ID-IC.
At an end of phase 1 the control element 304 forces 403 voltage Um up and the ID-IC detects the resulting rising edge of voltage Um. As a consequence, the system transfers to phase 2 at a beginning of which the ID-IC forces voltage Um up 401 if the bit pointed by the bit-pointer is ‘1’ or down 402 if said bit is ‘0’ for a time period T1. After the time period T1 the ID-IC returns to the high impedance state 410 and increments the bit-pointer to point the next bit of the digital data.
During phase 2 the control element 304 detects 420 the responded bit.

Therefore, the system is back at a beginning of phase 1 and the same operation restarts with an incremented bit-pointer. By repeating this operation the bits of the digital data can be read to the control element 304 in a serial form.

The bit-pointer can be arranged to wrap around when the number of bits transferred reaches the total number of bits to be transferred. A need for initialization the bit-pointer at the beginning of a data transfer may be avoided e.g. with an arrangement in which first bits at the beginning of the digital data represent a special delimiter bit-pattern for indicating the beginning of the digital data. This delimiter can be used for tracking the beginning of the data even if the reading is started at an arbitrary point (i.e. with an arbitrary value of the bit-pointer).

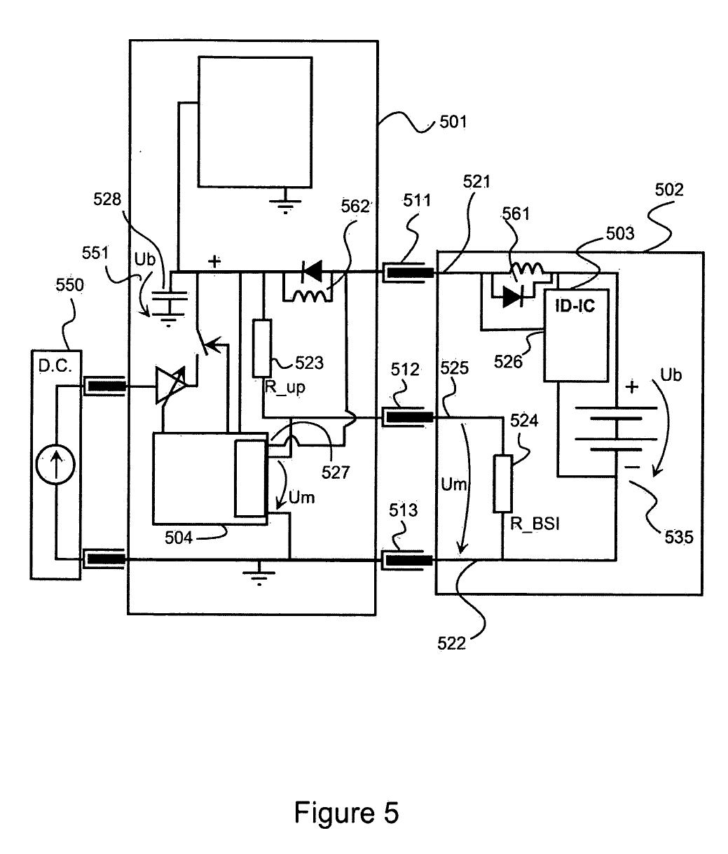

FIG. 5 shows an embodiment of the invention in which a ‘plus’ conductor 521 is used for a path for digital data from a battery element 502 to an electronic device 501. For short time periods electrical potential of the ‘plus’ conductor 521 can be drawn down to electrical potential of a ‘minus’ conductor 522 because of the fact that a system 561 consisted of a coil and a diode prevents a battery cell unit 535 from being short circuited. A system 562 consisted of a diode and a coil prevents supply voltage Ub 551 of the electronic device from being short circuited. The potential of the ‘plus’ conductor 521 is drawn down when either a terminal 527 of a control element 504 or a terminal 527 of a identification circuit 503 is coupled to the ‘minus’ conductor via a small impedance. This arrangement enables the control element 504 to send messages to the identification circuit 503 and vice versa. Therefore, the coils and the diodes are parts of communication means for transferring digital data from the battery element 502 to the electronic device 501. A drawback of this embodiment of the invention is naturally the fact that the supply voltage Ub requires filtering in order to avoid being distorted during transfer of digital data. A corresponding arrangement can be used for another embodiment of the invention in which the ‘minus’ conductor is used for a path for digital data. The polarity of the diodes has to be changed correspondingly.

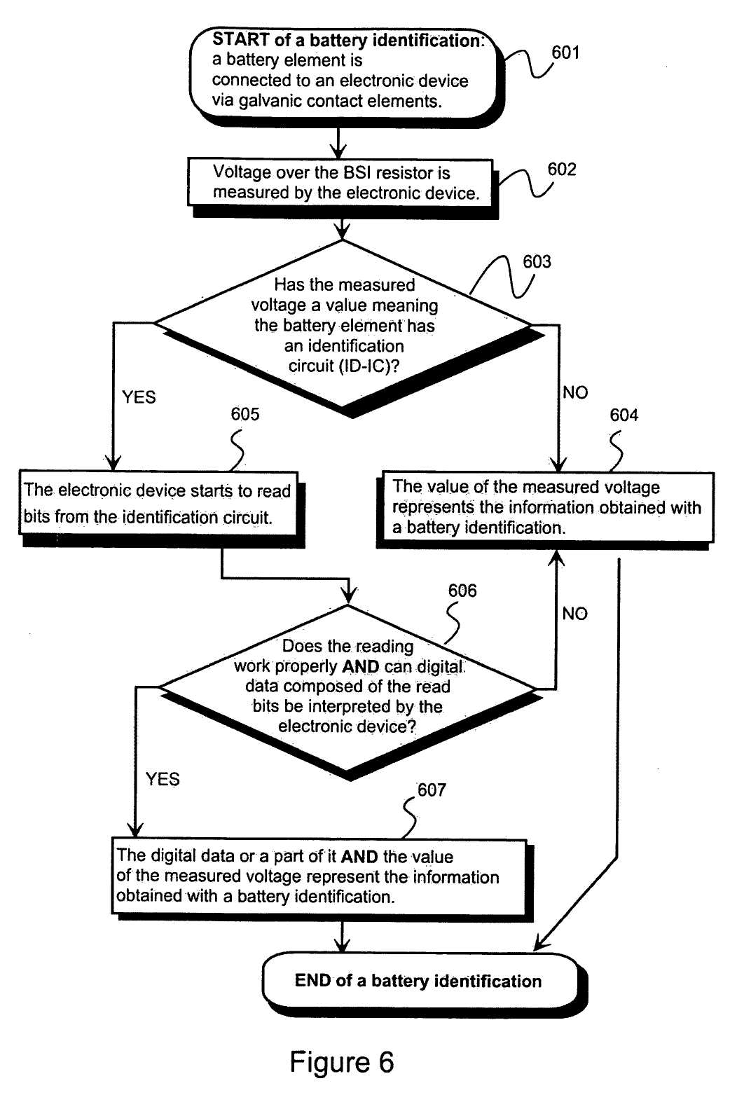

FIG. 6 shows a flowchart for a battery identification method according to an embodiment of the invention. In this embodiment battery identification is performed in steps described below. With respect to apparatus building blocks we refer to FIG. 3. In phase 601 a battery element 302 is connected to an electronic device 301 via electrical coupling elements 311, 312 and 313. If a battery cell unit 325 contains no charge it is naturally necessary that a charger device 350 has been connected to the system. In phase 602 voltage Um over the BSI resistor 324 is measured by the electronic device 301. During the measurement the input/output 326 of the identification circuit 303 has to be in a high impedance state in order not to corrupt the voltage measurement. In phase 603 it is checked if the measured voltage Um has a certain predetermined value meaning the battery element having an identification circuit (ID-IC). A more general approach is detecting a ratio of voltage Um to voltage between the ‘plus’ and the ‘minus’ conductors 321 and 322. With this approach changes in absolute voltage levels do not cause misinterpretations. If voltage Um (or the voltage ratio) does not have a value indicating existence of an identification circuit then the value of the measured voltage Um (or of the voltage ratio) represents the information obtained with the battery identification, phase 604. In the opposite case, the electronic device 301 starts to read bits from the identification circuit 303 in phase 605. In phase 606 it is checked if the reading of bits works properly and if the electronic device can interpret digital data composed of the read bits. If the result is positive the digital data or a part of it and the value of the measured voltage Um (or of the voltage ratio) represent the information obtained with the battery identification, phase 607. If the reading and/or the interpreting the digital data fail the value of the measured voltage Um (or of the voltage ratio) represents the information obtained with the battery identification, phase 605.

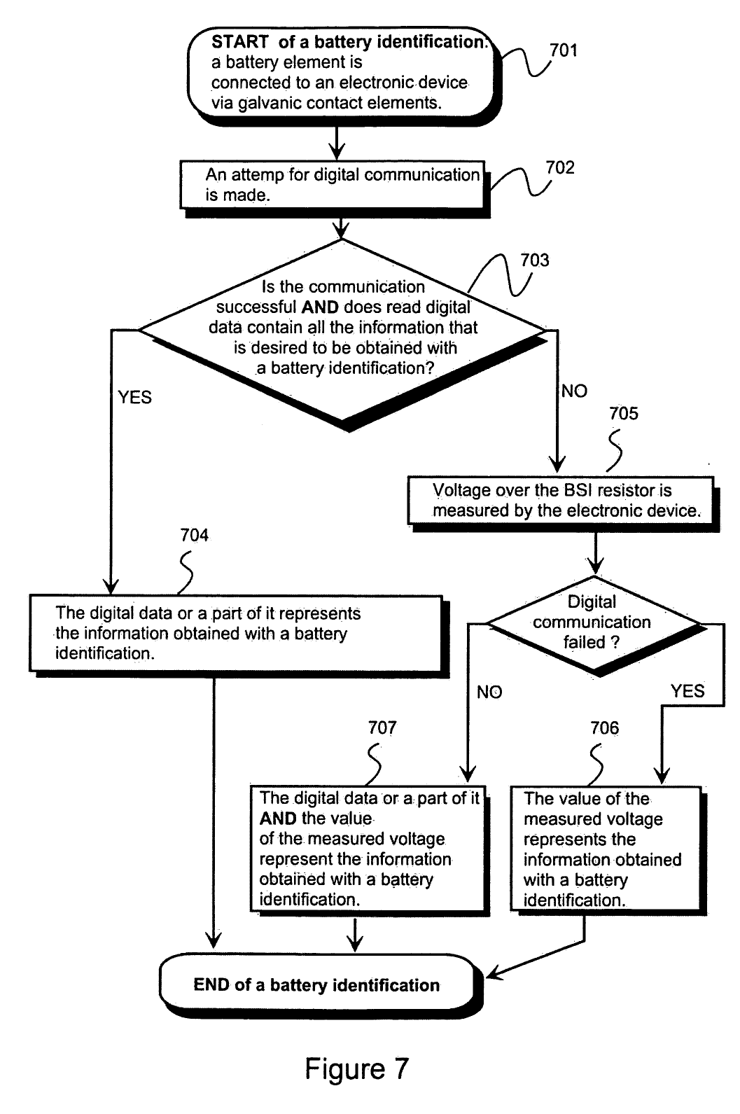

A flow chart representing a battery identification method according to another embodiment of the invention is shown by FIG. 7. In this embodiment battery identification is performed in steps described below. With respect to apparatus building blocks we refer to FIG. 3. In phase 701 a battery element 302 is connected to an electronic device 301 via electrical coupling elements 311, 312 and 313. In phase 702 an attempt for digital communication is made. A term ‘digital communication’ means here reading of bits from the battery element 302 to the electronic device 301 and interpreting digital data composed of the read bits in the electronic device 301. In phase 703 it is checked if the communication is successful and if received digital data contains all the information that is desired to be obtained with the battery identification. If the result is positive there is no need for measurement of voltage Um over the BSI resistor 324. In this case, the read digital data or a part of it represents the information obtained by the battery identification, phase 704. If the digital communication fails or if all desired information cannot be extracted from the read digital data the measurement of voltage Um over the BSI resistor 324 is performed in phase 705. If the digital communication failed the measured voltage Um (or the voltage ratio) represents alone the information obtained with the battery identification, phase 706. If the digital communication was successful but the read digital data did not represent all the desired information the digital data or a part of it and the value of the measured voltage Um (or of the voltage ratio) represent the information obtained with the battery identification, phase 707.

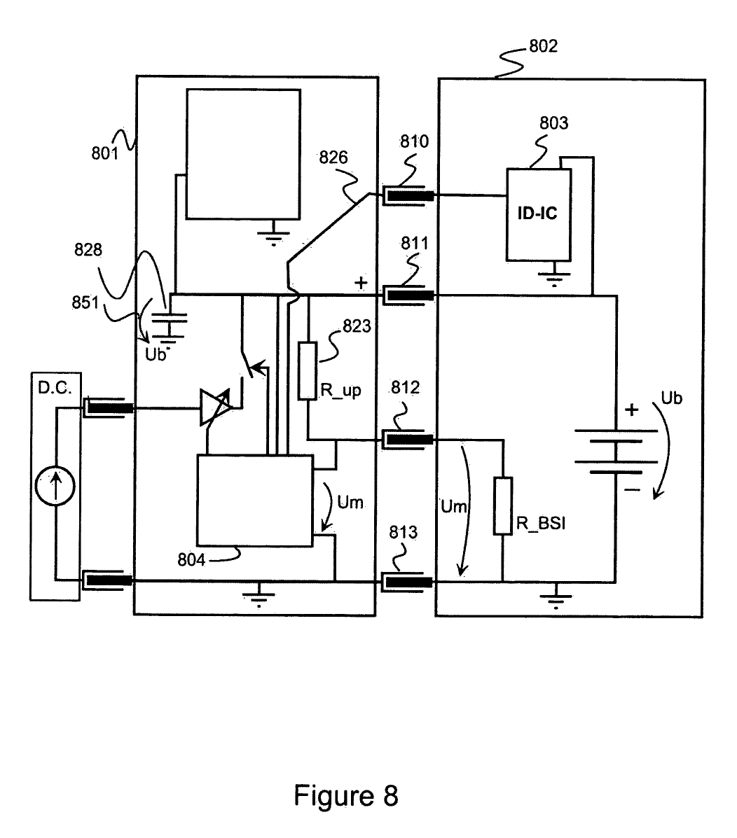

FIG. 8 shows an embodiment of the invention in which four electrical coupling elements 810, 811, 812 and 813 are used between a battery element 802 and an electronic device 801. Digital data is read from the battery element 802 via electrical conductor 826. Therefore, the conductor 826 and the electrical coupling element 810 are parts of communication means for transferring digital data from the battery element 802 to the electronic device 801. The communication between the electronic device and the battery element can be arranged to operate, for example, as described above with FIG. 4. With proper mechanical design an electronic device 801 according to this embodiment can be made to be compatible with older-generation battery elements having only three electrical coupling elements. When an older-generation battery element is coupled with the electronic device 801 the device side of the electrical coupling element 810 remains electrically unconnected and, naturally, any attempt to transfer digital data fails. The methods for battery identification described above with the flow charts shown in FIGS. 6 and 7 can be used with this embodiment of the invention. When an older-generation battery element is coupled with the electronic device 801 the value of the measured voltage Um (or of the voltage ratio) represent the information obtained with the battery identification.

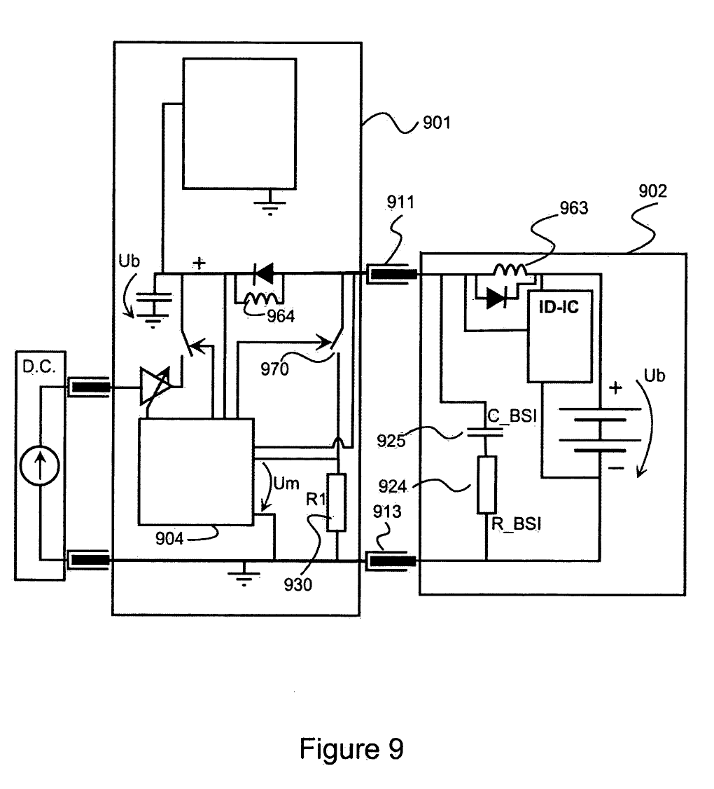

FIG. 9 shows an embodiment of the invention in which only two electrical coupling elements 911 and 913 are used between a battery element 902 and an electronic device 901. Digital data can be read from the battery element 902 to the electronic device 901 in a same way as described above with FIG. 5. Reading of analogue data is based on the fact that electrical current through coils 963 and 964 cannot be changed abruptly. Therefore, just after a time instant when a switch 970 is set to a conductive state the current through resistor 930 comes entirely from capacitor 925. The value of the current through the resistor 930 just after the switching event depends on the resistance of the resistor 930 and on the resistance of a BSI-resistor 924. There is actually a voltage slicing between resistors 930 and 924. The coils and diodes shown in FIG. 9 are parts of both communication means for transferring analogue data and of communication means for transferring digital data. The capacitor 925, the resistor 930, and the switch 970 are parts of the communication means for transferring digital data. The methods for battery identification described above with the flow charts shown in FIGS. 6 and 7 can be used with this embodiment of the invention. When an older-generation battery element is coupled with the electronic device 901 the value of the measured voltage Um (or of the voltage ratio) represent the information obtained with the battery identification.

In an embodiment of the invention digital data read from a battery element to an electronic device is used for selecting a charging algorithm. The selected charging algorithm determines charging parameters, for example, the maximum allowable values of charging current and charging voltage. The maximum allowable values may be functions of e.g. a charging status of the battery cell unit. The charging status can be detected, for example, by measuring voltage produced by the battery cell unit at certain time intervals. The charging algorithm may also determine what kind of phenomenon is used for indicating a full charge state. A usable indicator for a full charge state depends on the chemistry of a battery cell. For example, with certain battery types a level of voltage produced by a battery cell unit can be used as an indicator for a full charge state. In an embodiment of the invention the digital data can contain information about a battery discharge curve. The discharge curve can, for example, express the amount of utilizable energy stored in a battery element as a function of voltage level produced by the battery element. This makes it possible to improve the accuracy of a user interface that informs a user of an electronic device about remaining battery capacity. In an embodiment of the invention digital data read from a battery element to an electronic device comprises a serial number of the battery element. This serial number can be stored in a memory element being in the electronic device. The serial number can be used, for example, in possible future authentication purposes.

In the presented embodiments of the invention shown in FIGS. 3, 5 and 8 battery removal detection works in a way that when a battery element 302, 502, 802 is removed a pull-up resistor 323, 523, 823 pulls voltage Um up to supply voltage Ub 351, 551, 851. Battery removal is detected based on a rising edge in the voltage Um. During a time period needed for the removal detection, the supply voltage Ub can be maintained with an arrangement in which an electrical connection via an electrical coupling element 312, 512, 812 between the pull-up resistor and a BSI resistor is broken earlier than electrical connections via electrical coupling elements 311 and 313, 511 and 513, 811 and 813 that deliver the supply voltage. The supply voltage Ub can be maintained also with the aid of energy storages 328, 528, 828. The energy storages 328, 528, 828 are in FIGS. 3, 5 and 8 presented as a single capacitor, but from the viewpoint of this invention it is immaterial how the supply voltage Ub 351, 551, 851 is maintained for a sufficiently long time period after battery removal.

In the presented embodiments of the invention the control element 304, 504, 804 and 904 can be realized with a programmable processor plus a software product comprising software means stored on a readable medium for execution by the processor, the software means for performing and/or controlling the above-mentioned functions like reading digital data from a battery element to an electronic device, reading analogue data from a battery element to an electronic device, controlling the battery identification process, controlling charging of a battery cell unit, and illustrating battery charging status via a user interface. As another option a control element can be realized with one or more dedicated circuits that is/are designed to perform the above mentioned operations. In this case electrical connections between logic ports and other elements of a circuit form the intelligence that controls the operations. A dedicated circuit can be e.g. an application specific integrated circuit (ASIC). A control element can also be realized with one or more field programmable gate array (FPGA) components. A FPGA component is configured before its operation with configuration software to emulate a dedicated circuit. Furthermore, a control element can be a hybrid construction comprising at least two from the following list: a programmable processor plus a corresponding software product, a dedicated circuit, a field programmable gate array component plus appropriate configuration software.

Electrical coupling elements between a battery element and an electronic device are preferably galvanic contact elements. In principle the one or more of electrical coupling elements between the battery element can be based on a capacitive or inductive coupling or both, but this leads to a more complex technical solution with d.c-a.c. conversions, because d.c. power/signal cannot be transferred through an inductive or capacitive electrical contact element.

It is obvious to a person skilled in the art that the invention and its embodiments are thus not limited to the above-described examples, but may vary within the scope of the independent claims. For example, an analogue interface between an electronic device and a fuel cell battery element can be supplemented according to the invention by a digital interface.

1. An interface arrangement between a battery element and an electronic device, comprising:
at least two electrical coupling elements between the battery element and the electronic device,
a storage unit for digital data associated with the battery element, the storage unit being a part of the battery element,
a component disposed to represent analogue data associated with the battery element, the component being a part of the battery element,
first communication circuitry configured to transfer said analogue data from the battery element to the electronic device via at least one of the electrical coupling elements, and
second communication circuitry configured to transfer said digital data from the battery element to the electronic device via at least one of the electrical coupling elements.

2. The interface arrangement between a battery element and an electronic device according to claim 1, wherein the electronic device is a mobile phone.

3. The interface arrangement between a battery element and an electronic device according to claim 1, wherein said component disposed to represent said analogue data associated with the battery element is a battery size indication resistor.

4. The interface arrangement between a battery element and an electronic device according to claim 3, comprising means for supplying electrical power to said battery size indication resistor and for measuring an electrical quantity dependent at least partly on a resistance of said battery size indication resistor.

5. The interface arrangement between a battery element and an electronic device according to claim 4, comprising a first electrical coupling element for electrically connecting a ‘plus’ conductor of the battery element to the electronic device, a second electrical coupling element for electrically connecting a ‘minus’ conductor of the battery element to the electronic device, and a third electrical coupling contact element for electrically connecting a first terminal of said battery size indication resistor to the electronic device.

6. The interface arrangement between a battery element and an electronic device according to claim 5, wherein said means for supplying electrical power to said battery size indication resistor and for measuring the electrical quantity dependent at least partly on the resistance of said battery size indication resistor comprise a pull-up resistor a first terminal of which is coupled electrically to the ‘plus’ conductor of the battery element via the first electrical coupling element and a second terminal of which is coupled electrically to the first terminal of said battery size indication resistor via the third electrical coupling element.

7. The interface arrangement between a battery element and an electronic device according to claim 6, wherein a second terminal of said battery size indication resistor is electrically coupled with the ‘minus’ conductor of the battery element.

8. The interface arrangement between a battery element and an electronic device according to claim 6, comprising means for transferring said digital data from the battery element to the electronic device via the third electrical coupling element.

9. The interface arrangement between a battery element and an electronic device according to claim 6, comprising means for transferring said digital data from the battery element to the electronic device via the first electrical coupling element.

10. The interface arrangement between a battery element and an electronic device according to claim 6, comprising means for transferring said digital data from the battery element to the electronic device via the second electrical coupling element.

11. The interface arrangement between a battery element and an electronic device according to claim 1, wherein at least one electrical coupling element is a galvanic contact element.

12. The interface arrangement between a battery element and an electronic device according to claim 1, wherein said digital data comprises at least one charging parameter of the battery element.

13. The interface arrangement between a battery element and an electronic device according to claim 1, wherein said digital data comprises a discharge curve of the battery element.

14. The interface arrangement between a battery element and an electronic device according to claim 1, wherein said digital data comprises a serial number of the battery element.

15. A battery element comprising at least one re-chargeable battery cell and at least two electrical coupling elements for forming electrical connections to an electronic device, wherein the battery element comprises:
a storage unit for digital data associated with the battery element,
a component disposed to represent analogue data associated with the battery element,
first communication circuitry configured to make said analogue data accessible to the electronic device via at least one of the electrical coupling elements, and
second communication circuitry configured to make said digital data accessible to the electronic device via at least one of the electrical coupling elements.

16. The battery element according to claim 15, wherein said component disposed to represent said analogue data associated with the battery element is a battery size indication resistor.

17. The battery element according to claim 16, comprising a first electrical coupling element for electrically connecting a ‘plus’ conductor of the battery element to the electronic device, a second electrical coupling element for electrically connecting a ‘minus’ conductor of the battery element to the electronic device, and a third electrical coupling element for electrically connecting a first terminal of said battery size indication resistor to the electronic device.

18. The battery element according to claim 17, comprising means for making said digital data accessible to the electronic device via the third electrical coupling element.

19. The battery element according to claim 17, comprising means for making said digital data accessible to the electronic device via the first electrical coupling element.

20. The battery element according to claim 17, comprising means for making said digital data accessible to the electronic device via the second electrical coupling element.

21. The battery element according to claim 17, wherein a second terminal of said battery size indication resistor is electrically coupled with the ‘minus’ conductor of the battery element.

22. The battery element according to claim 15, wherein at least one electrical coupling element is a galvanic contact element.

23. The battery element according to claim 15, wherein said digital data comprises at least one charging parameter of the battery element.

24. The battery element according to claim 15, wherein said digital data comprises a discharge curve of the battery element.

25. The battery element according to claim 15, wherein said digital data comprises a serial number of the battery element.

26. An electronic device comprising at least two electrical coupling elements for forming electrical connections to a battery element, wherein the electronic device comprises:
a first communication circuitry configured to read analogue data from the battery element via at least one of the electrical coupling elements, and
a second communication circuitry configured to read digital data from the battery element via at least one of the electrical coupling elements.

27. The electronic device according to claim 26, wherein the electronic device is a mobile phone.

28. The electronic device according to claim 26, comprising a first electrical coupling element for electrically connecting the electronic device to a ‘plus’ conductor of the battery element, a second electrical coupling element for electrically connecting the electronic device to a ‘minus’ conductor of the battery element, and also a third electrical coupling element for electrically connecting the electronic device to the battery element.

29. The electronic device according to claim 28, comprising means for supplying electrical power via said third electrical coupling element and for measuring an electrical quantity associated with the third electrical coupling element.

30. The electronic device according to claim 29, wherein said means for supplying electrical power via said third electrical coupling element and for measuring the electrical quantity associated with the third electrical coupling element comprise a pull-up resistor a first terminal of which is coupled electrically to said first electrical coupling element and a second terminal of which is coupled electrically to said third electrical coupling element.

31. The electronic device according to claim 28, comprising means for reading said digital data via the third electrical coupling element.

32. The electronic device according to claim 28, comprising means for reading said digital data via the first electrical coupling element.

33. The electronic device according to claim 28, comprising means for reading said digital data via the second electrical coupling element.

34. The electronic device according to claim 26, wherein at least one electrical coupling element is a galvanic contact element.

35. A method for identification a battery element electrically connected to an electronic device via at least two electrical coupling elements, the method comprising:
reading analogue data from the battery element to the electrical device via at least one of the electrical coupling elements, and
reading digital data from the battery element to the electrical device via at least one of the electrical coupling elements.

36. The method according to claim 35, comprising representing analogue data associated with the battery element using a battery size indication resistor, hereinafter a battery size indication resistor, the battery size indication resistor being a part of the battery element.

37. The method according to claim 36, comprising connecting the electronic device electrically to a ‘plus’ conductor of the battery element via a first electrical coupling element, connecting the electronic device electrically to a ‘minus’ conductor of the battery element via a second electrical coupling element, and connecting the electronic device electrically to an open terminal of the battery size indication resistor of the battery element via a third electrical coupling element.

38. The method according to claim 37, comprising supplying electrical power to said battery size indication resistor and measuring an electrical quantity dependent at least partly on a resistance of said battery size indication resistor.

39. The method according to claim 37, comprising reading said digital data from the battery element to the electronic device via the third electrical coupling element.

40. The method according to claim 37, comprising reading said digital data from the battery element to the electronic device via the first electrical coupling element.

41. The method according to claim 37, comprising reading said digital data from the battery element to the electronic device via the second electrical coupling element.

42. The method according to claim 35, wherein at least one charging parameter of the battery element is extracted from said digital data.

43. The method according to claim 35, wherein a discharge curve of the battery element is extracted from said digital data.

44. The method according to claim 35, wherein a serial number of the battery element is extracted from said digital data.

45. A software product stored on a computer readable medium for execution by a processor for identification of a battery element electrically connected to an electronic device via at least two electrical coupling elements, the software product comprising:
a first software module disposed to configure the electronic device for reading analogue data from the battery element to the electronic device via at least one of the electrical coupling elements, and
a second software module disposed to configure the electronic device for reading digital data from the battery element to the electronic device via at least one of the electrical coupling elements.

46. The software product according to claim 45, comprising software for measuring an electrical quantity associated with at least one of the electrical coupling elements.

47. The software product according to claim 45, comprising software for reading said digital data from the battery element to the electronic device via a electrical coupling element that couples a ‘plus’ conductor of the battery element to the electronic device.

48. The software product according to claim 45, comprising software for reading said digital data from the battery element to the electronic device via a electrical coupling element that couples a ‘minus’ conductor of the battery element to the electronic device.

49. The software product according to claim 45, comprising software for reading said digital data from the battery element to the electronic device via a electrical coupling element that electrically couples an open terminal of a battery size indication resistor to the electronic device.

50. The software product according to claim 45, comprising software for extracting at least one charging parameter of the battery element from said digital data.

51. The software product according to claim 45, comprising software for extracting a discharge curve of the battery element from said digital data.

52. The software product according to claim 45, comprising software for extracting a serial number of the battery element from said digital data.
